(19) United States
(12) Patent Application Publication
(10) Pub. No.: US 2002/0010768 A1
(43) Pub. Date: Jan. 24, 2002

(54) AN ENTITY MODEL THAT ENABLES PRIVILEGE TRACKING ACROSS MULTIPLE TREMINALS

(76) Inventors: JOSHUA K. MARKS, FREMONT, CA (US); STEVE L. STRASNICK, MOUNTAIN VIEW, CA (US); LANCE H. MORTENSEN, ALAMO, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/213,614

(22) Filed: Dec. 17, 1998

(51) Int. Cl. G06F 15/16; G06F 15/173; G06F 12/14; G06F 11/30; H04L 9/32

(52) U.S. Cl. 709/223; 709/225; 709/227

(57) ABSTRACT

A method and apparatus that allows a user of a networked device, such as a computer system or a set-top box, to have access privileges based on user identity and the network device (e.g., terminal) used to access the network is disclosed. In one embodiment, authorized users of the network have a user identity (e.g., login name and password) that identifies the user. Each authorized user of the network has a set of user privileges. The user privileges identify local resources (e.g., applications) and network resources (e.g., World Wide Web pages) that are available to the user. In one embodiment, user privileges to particular applications, whether local or remote, are determined based on whether the user is current in access fees (i.e., billing status). In one embodiment, each device connected to the network has associated with it a set of device access privileges that identify local resources and network resources that are provided by and allowed by the device. When an authorized user of the network logs in at a terminal, that user is provided with session privileges that are the intersection of the individual user privileges and the device privileges of the device on which the user is logged in.

### FIELD OF THE INVENTION

The present invention relates to networked terminals that provide access to network resources. More particularly, the present invention relates to an entity model that enables assigning, tracking, and management of user and session access privileges across multiple terminals having access to network resources.

### BACKGROUND OF THE INVENTION

Local area networks are commonly used to pool resources, such as a printer or file server, between many users each having individual terminals coupled to the network. Local area networks can also be used to provide access to resources beyond the local area network via devices such as routers, firewalls and proxy servers. Thus, a single user can access resources on a local area network from a terminal coupled to the network as well as from another local area network. Similarly, users can access resources on an external network, such as the Internet, from both local area networks.

Typically, when a user logs in to a network using a particular terminal, network privileges are provided based on the identity of the user. One shortcoming of these networks is that local access privileges are determined based on a user identification only. Another shortcoming is that when the user moves to a different terminal within the network or to a terminal on a different network, the user may not be able to login, or the user's access privilege may change and/or the interface provided to the user may be significantly different than what the user is used to using. For example, resources available on a first terminal may not be available on a second terminal. This may confuse or frustrate users and/or network administrators.

What is needed is a network management scheme that provides users with a consistent set of access privileges and a consistent user experience based on, for example, both user identity and terminal identification. Such a network management scheme can be especially useful in an environment, such as a school, where access privileges are carefully controlled, and users do not have dedicated (e.g., personal) workstations.

### SUMMARY OF THE INVENTION

A method and apparatus for managing networked devices to allow tracking of access privileges across multiple terminals and across multiple interconnected networks is described. Session privileges are determined based on the intersection of a set of user privileges for a user of a device and a set of device privileges and resources associated with the device. Access to resources is granted based, at least in part, on the session privileges. In one embodiment, a user interface is configured based, at least in part, on the session privileges.

In one embodiment, the set of user privileges includes access privileges to one or more local resources based, at least in part, on user identity and access privileges to one or more remote resources based, at least in part, on user identity. In one embodiment, the set of device privileges includes access privileges to one or more local resources based, at least in part, on device identity and access privileges to one or more remote resources based, at least in part, on device identity. In one embodiment, remote resources are replicated or mirrored on a local network.

### BRIEF DESCRIPTION OF THE DRAWINGS

The present invention is illustrated by way of example, and not by way of limitation in the figures of the accompanying drawings in which like reference numerals refer to similar elements.

FIG. 1 is a network configuration suitable for use with the present invention.

FIG. 2 is a network operations center coupled to a network suitable for use with the present invention.

FIG. 3 is a computer suitable for use with the present invention.

FIG. 4 is an entity relationship model suitable for use with the present invention.

FIG. 5 is a flow diagram of a user login according to one embodiment of the present invention.

FIG. 6 is a layout of a graphical user interface according to one embodiment of the present invention.

### DETAILED DESCRIPTION

A method and apparatus for managing networked devices to allow tracking and dynamic generation of access privileges across multiple terminals and for multiple registered users is described. In the following description, for purposes of explanation, numerous specific details are set forth in order to provide a thorough understanding of the present invention. It will be apparent, however, to one skilled in the art that the present invention can be practiced without these specific details. In other instances, structures and devices are shown in block diagram form in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The present invention allows a user of a networked device, such as a computer system or a set-top box, to have access privileges based on user identity and the network device (e.g., terminal) used to access the network. In one embodiment, authorized users of the network have a user identity (e.g., login name and password) that identifies the user. Each authorized user of the network has a set of user privileges. The user privileges identify local resources (e.g., applications, media files) and network resources (e.g., World Wide Web pages, communications protocols, content channels) that are available to the user. In one embodiment, user access to particular applications, whether local or remote, are determined based on whether the user is current in access fees (i.e., billing status), if the resource is otherwise available to the user and the terminal being used.

In one embodiment, each device connected to the network has an associated set of device privileges that identify local resources and network resources that are provided by the device. When an authorized user of the network logs in at a terminal, that user is provided with session privileges that are the intersection of the individual user privileges and the device privileges of the device on which the user is logged in. Thus, a consistent, but not necessarily constant, set of access privileges can be provided to users regardless of the device used to access the individual resources. In other words, the user has access to all resources that the user has rights to, so long as those resources are available (based both on technical availability and usage policy) to the specific terminal being used regardless of the terminal being used and the location of the terminal.

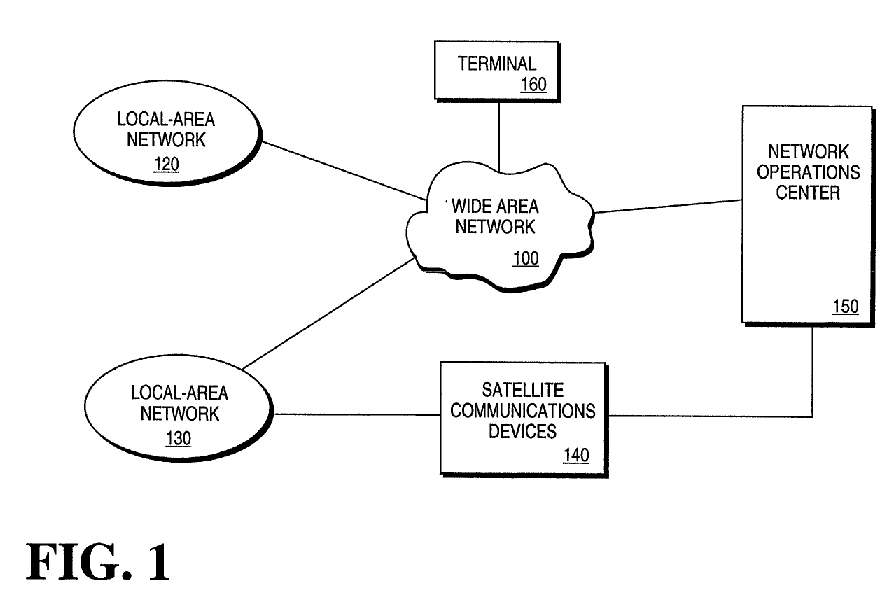

FIG. 1 is a network configuration suitable for use with the present invention. The configuration of FIG. 1 is described in terms of both land based communications and satellite communications; however, the manner of communication is not central to the present invention. Therefore, the present invention is applicable to any interconnection of devices that provide access to local and remote resources.

Wide area network 100 provides an interconnection between multiple local area networks (e.g., 120 and 130), individual terminals (e.g., 160) and one or more network operations centers (e.g., 150). In one embodiment, wide area network 100 is the Internet; however, any wide area network (WAN) or other interconnection can be used to implement wide area network 100.

Terminal 160 is an individual terminal that provides access to network resources as well as local resources for a user thereof. In one embodiment, terminal 160 is a personal computer connected to wide area network 100 via a modem, a wireless connection, etc. Alternatively, terminal 160 can be a set-top box such as a WebTV™ terminal available from Sony Electronics, Inc. of Park Ridge, N.J., or a set-top box using a cable modem to access a network such as the Internet. Similarly, terminal 160 can be a “dumb” terminal, or a thin client device such as the ThinSTAR™ available from Network Computing Devices, Inc. of Mountain View, Calif.

Local area network 120 provides an interconnection of devices at a local level. For example, local area network 120 can interconnect multiple computers, printers, and other devices within one or more buildings. Local area network 120 is coupled to wide area network 100. Similarly, local area network 130 provides an interconnection of devices. However, local area network 130 is coupled to satellite communications devices 140 as well as wide area network 100.

Network operations center 150 is coupled to wide area network 100 and provides access to network resources for terminal 160, local area network 120 and local area network 130. Communication between network communications center 150 and either terminal 160 or local area network 120 is accomplished by wide area network 100. As described in greater detail below, network operations center 150 and local area network 130 communicate via wide area network 100 and/or satellite communications devices 140.

In one embodiment network operations center 150 includes multiple servers (not shown in FIG. 1) that provide access to network and other resources. For example, network operations center 150 can include a Web proxy server that provides access to the World Wide Web (WWW, or the Web) for devices of local area network 120, local area network 130 and terminal 160. Network operations center 150 can also include other devices, such as a middleware server or a file server that provide information to devices coupled to network operations center 150.

In one embodiment, information is communicated between network operations center 150 and local area network 130 via satellite communications devices 140, which includes necessary components to provide communications between network operations center 150 and local area network 130. In one embodiment, satellite communication are accomplished using Transmission Control Protocol/Internet Protocol (TCP/IP) embedded within a Digital Video Broadcast (DVB) stream; however, any sufficient communication protocol can be used. In one embodiment, satellite communications are bi-directional. Alternatively, if satellite communications are uni-directional, wide area network 100 can be used to provide a hybrid asymmetrical bi-directional communications system such as the SkySurfer™ platform available from Gilat Satellite Networks, Inc. of McLean, Va.

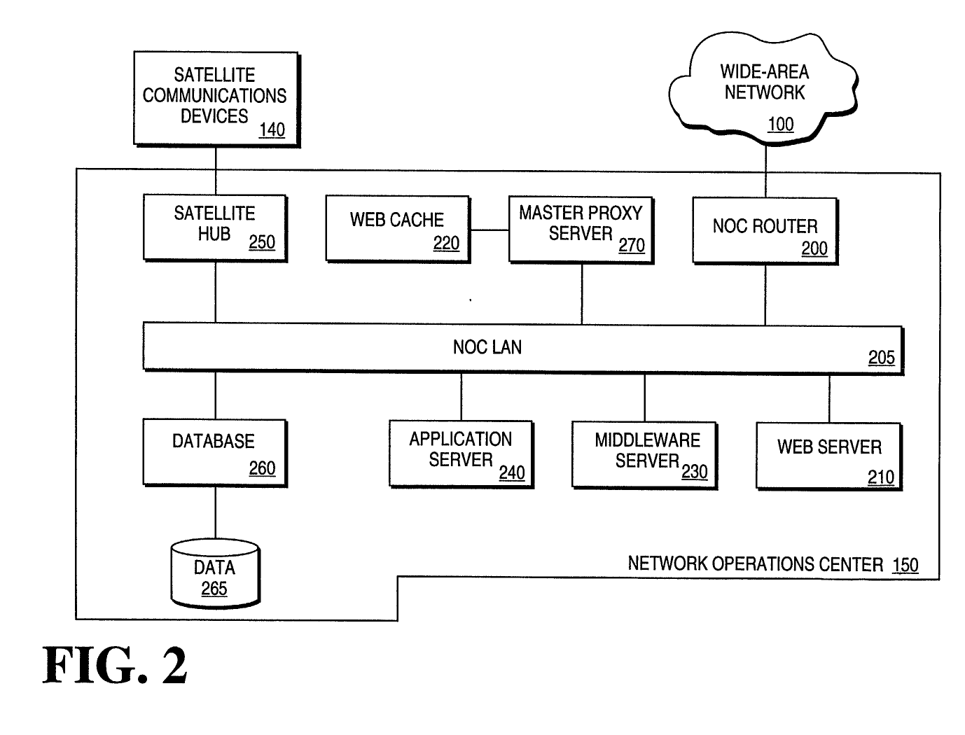

FIG. 2 is one embodiment of a network operations center coupled to a network suitable for use with the present invention. With respect to description of FIG. 2, wide area network 100 and satellite communications devices 140 are implemented as described above in FIG. 1. Notwithstanding being described as including certain types of servers and other devices, network operations center 150 can include different or additional components as well as multiple components, for example, multiple Web servers. Each server can be one or more software and/or hardware components.

Network operations center (NOC) 150 provides resources to local area networks and individual terminals (not shown in FIG. 2) as well as, in one embodiment, a gateway to a larger network such as the Internet. Thus, network operations center 150 can be used to provide a controlled set of resources while being part of a larger network. This is particularly advantageous in situations where users of the local area networks are somewhat homogenous. For example, students in similar grade levels, professionals, and other groups.

Additional uses and details of network operations center configuration can be found in U.S. patent application Ser. No. 09/XXX,XXX (P001), entitled “OPTIMIZING BANDWIDTH CONSUMPTION FOR DOCUMENT DISTRIBUTION OVER A MULTICAST ENABLED WIDE AREA NETWORK” and U.S. patent application Ser. No. 09/XXX,XXX (P002), entitled “A METHOD AND APPARATUS FOR SUPPORTING A MULTICAST RESPONSE TO A UNICAST REQUEST FOR DATA,” both of which are assigned to the corporate assignee of the present invention.

NOC router 200 is coupled to NOC LAN 205 and provides routing and firewall functionality for the servers and other components of network operations center 150. NOC router 200 can be implemented in any manner known in the art. In one embodiment, database 260 is coupled to NOC LAN 205. Database 260 can be used, for example, to store information about authorized users of associated local area networks, or to store information about resources that are available on each terminal connected to the network. Database 260 can also be used to store statistics about network usage, advertisements to be downloaded to devices of the local area networks, etc. Data 265 represents data stored by database 260 and can be one or more physical devices.

Master proxy server 270 is also coupled to NOC LAN 205 to provide World Wide Web resources to devices of the connected local area network(s) or individual terminals. In one embodiment web server 210 is a Hypertext Markup Language (HTML) and/or Secure Sockets Layer (SSL) server. Of course, Web server 210 can be another type of server. Web cache 220 is used to store Web resources (e.g., Web pages) that are most often accessed, most recently accessed, etc. In one embodiment, Web cache 220 stores a predetermined set of Web resources that are provided to the local area networks. In a school network environment, the cached Web resources can be, for example, a preapproved set of Web pages. In one embodiment all or a portion of the contents of Web cache 220 are replicated on local networks.

Middleware server 230 manages database applications in network operations center 150. For example, middleware server 230 can determine which users have access to Web server 210. By querying the user database, middleware server 230 acts as an interface between clients and servers as well as between servers. In one embodiment, middleware server 230 is implemented using WebObjects® available from Apple Computer, Inc. of Cupertino, California, or a similar database middleware product. Alternatively, each client and server can act as its own middleware device by interfacing with the database servers on their own behalf though existing database interfacing technologies such as the Common Object Request Broker Architecture (CORBA) as defined by Object Management Group, Inc. of Framingham, Mass. or COM+available from Microsoft Corporation of Richmond, Wash.

Application server 240 provides applications programs to devices coupled to network operations center 150. For example, application server 240 can provide HTML-formatted e-mail services to one or more devices. Application server 240 can also run and manage run-time applications on client terminals connected local area networks.

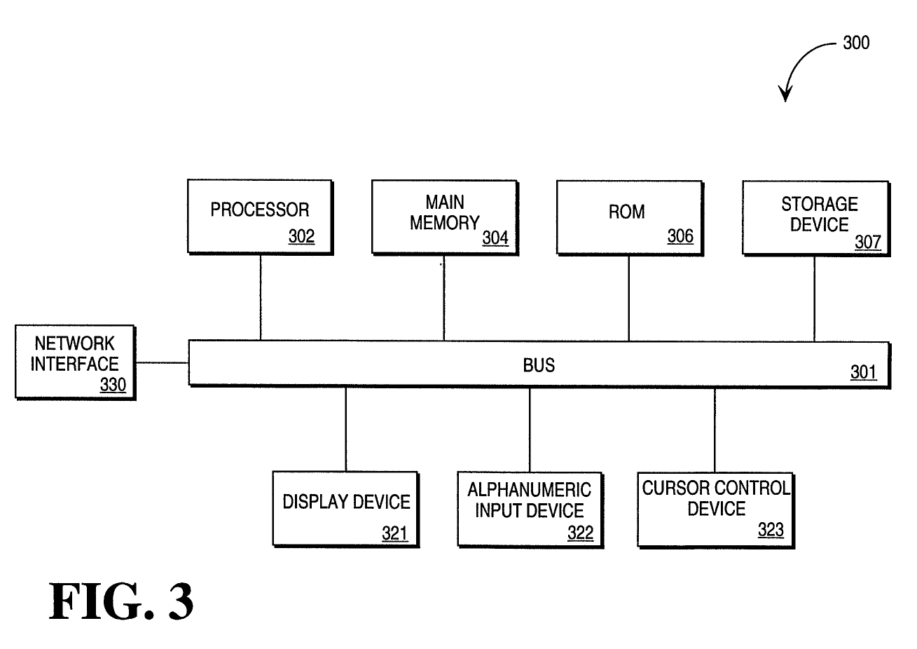

FIG. 3 is a computer system suitable for use with the present invention. Computer system 300 can be used as a device within local area networks 120 and 130 or as terminal 160. Computer system 300 can also be used for one or more devices of network operations center 150.

Computer system 300 includes bus 301 or other communication device for communicating information and processor 302 coupled to bus 301 for processing information. Computer system 300 further includes random access memory (RAM) or other dynamic storage device 304 (referred to as main memory), coupled to bus 301 for storing information and instructions to be executed by processor 302. Main memory 304 also can be used for storing temporary variables or other intermediate information during execution of instructions by processor 302. Computer system 300 also includes read only memory (ROM) and/or other static storage device 306 coupled to bus 301 for storing static information and instructions for processor 302. Data storage device 307 is coupled to bus 301 for storing information and instructions.

Data storage device 307 such as a magnetic disk or optical disc and corresponding drive can be coupled to computer system 300. Computer system 300 can also be coupled via bus 301 to display device 321, such as a cathode ray tube (CRT) or liquid crystal display (LCD), for displaying information to a computer user. Alphanumeric input device 322, including alphanumeric and other keys, is typically coupled to bus 301 for communicating information and command selections to processor 302. Another type of user input device is cursor control 323, such as a mouse, a trackball, or cursor direction keys for communicating direction information and command selections to processor 302 and for controlling cursor movement on display 321.

Computer system 300 further includes network interface 330 to provide access to a network, such as a local area network. One embodiment of the present invention is related to the use of computer system 300 to provide access to remote and/of local resources. According to one embodiment, all or a portion of providing access to remote and/or local resources is performed by computer system 300 in response to processor 302 executing sequences of instructions contained in memory 304. Execution of the sequences of instructions contained in memory 304 causes processor 302 to provide access to remote and/or local resources, as described herein.

Instructions are provided to main memory 304 from a storage device, such as magnetic disk, a read-only memory (ROM) integrated circuit (IC), CD-ROM, DVD, via a remote connection (e.g., over a network via network interface 330), etc. In alternative embodiments, hard-wired circuitry can be used in place of or in combination with software instructions to implement the present invention. Thus, the present invention is not limited to any specific combination of hardware circuitry and software instructions.

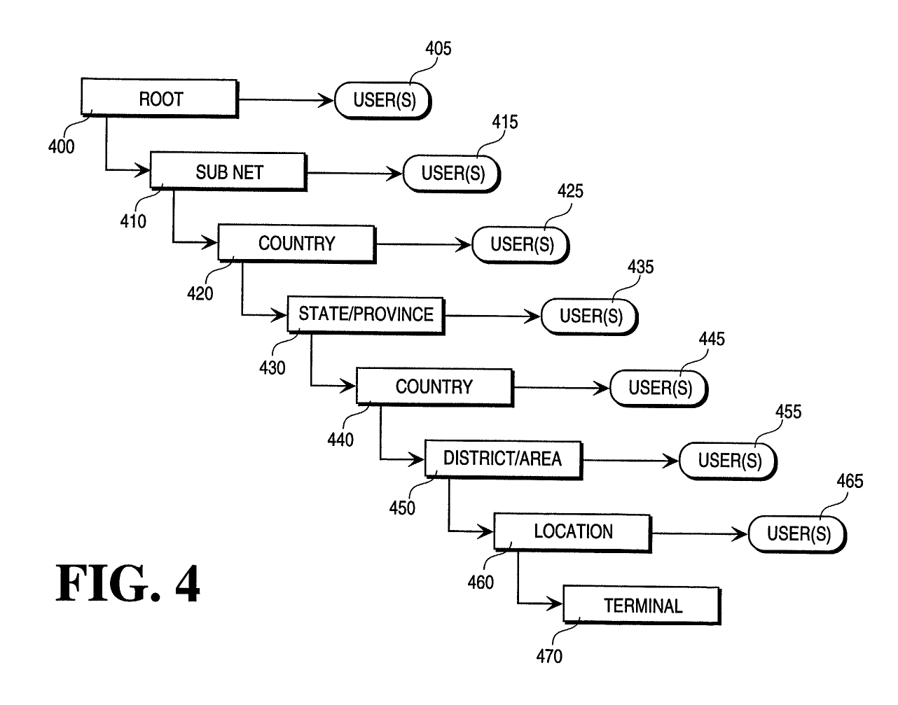

FIG. 4 is one embodiment of an entity relationship model suitable for use with the present invention. In one embodiment, each entity of FIG. 4 has an associated set of privileges, both for local access (e.g., the device being used) and for network privileges. Of course, other entities as well as a different number of entities and entity class relationships can also be used. In one embodiment, within the various entity levels, multiple classes of users (e.g., teachers, local administrators, students, guests) can be defined where each class of users can have different default and maximum access privileges.

Root entity 400 represents the lowest level (greatest amount) of access available to an entity. User(s) 405 associated with root entity 400 can be, for example, an network administrator at network operations center 150. In one embodiment, the number of users 405 associated with root entity 400 is relatively small because of the amount of access to the complete network. In another embodiment, all classes of users supported by the network are defined at the root level, as well as the maximum privileges for each class. In this embodiment, session privileges available to a specific class of user are defined by the terminal/location entity where the user is logged in and/or associated with, possibly less then but not more then the maximum privileges for that class of user.

Subnet entity 410 represents a higher level (lesser amount) of access as compared to root entity 400. User(s) 415 associated with subnet entity 410 have access to portions of the complete network. Subnets can be divided by region (e.g., South America), language (e.g., English), ethnicity (e.g., Chinese). Country entity 420 allows user(s) 425 access to the portion of the complete network within a specific country.

In one embodiment, each sub-entity can be individually configured within the set of privileges provided by the parent entity for each class of user supported and defined within that entity. If left unmodified, however, each sub-entity inherits the set of privileges and supported user classes of the parent entity. Thus, users of a given class associated with each entity can restrict, but not enlarge the set of user class privileges provided by a specific entity for a class of user.

State entity 430 allows user(s) 435 access to portions of the network within a specific state/province. County entity 440 allows user(s) 445 access to portions of the network within a specific county. District/area entity 450 allows user(s) 455 access to a district (e.g., school district) portion of the network within a specific state. Location entity 460 allows user(s) 465 access to a portion of the network within a specific location (e.g., a specific school). Terminal entity 470 is the lowest level entity allowing the most restrictive access of the entities described with respect to FIG. 4 for users of each class. In one embodiment, a class of users can be defined at any level of entity and are valid at all lower entity levels. Alternatively, a class of users may not have access below a particular level.

In one embodiment, each entity within the entity model of FIG. 4 has a specific set of associated privileges for each class of user supported by that entity and for each terminal associated with the entity level. The intersection of entity privileges and user privileges for the user of the terminals associated with a specific entity determines the network access privileges granted to a specific user during a session on a specific terminal of the network. For example, user 465 has a predetermined set of user privileges. Similarly, terminal 470 has a predetermined set of entity (device, terminal) privileges. The intersection of the user privileges with the entity privileges determines the network access (or session) privileges granted to the user while he/she is using the specific terminal. Network access privileges are similarly determined at each level of the entity model.

In one embodiment users of a specific class at a particular level of the hierarchy described can use entities at the same level of the hierarchy in a different “branch” and have session privileges granted in a similar manner. For example, if a user who is a student at his/her school uses a terminal at his/her school, the user has session privileges that are the intersection of the device privileges as set by the school (e.g., location entity) and his/her user privileges. If that student uses a terminal at a different school having a different set of device privileges, the student is granted session privileges that are the intersection of his/her user privileges and the device privileges of the terminal at the other school.

In one embodiment maximum access privileges are defined by the entity to which a class of user belongs. For example, the default maximum terminal privileges are defined by the terminal's location entity (e.g., a school in which the terminal resides). Thus access privileges are controlled in a hierarchical manner.

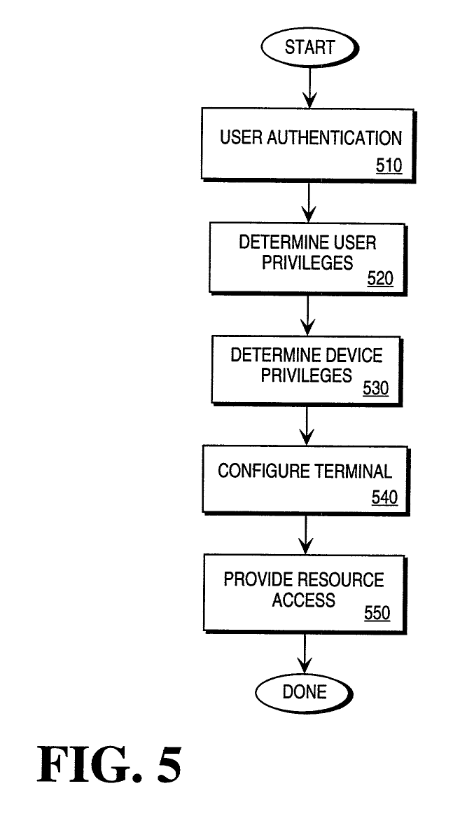

FIG. 5 is a flow diagram of a user login according to one embodiment of the present invention. A user that wishes to use a terminal that is part of the network is authenticated at 510. In one embodiment, the user is provided a login screen that prompts for information identifying the user to the network, for example, a login name and a password. The terminal then communicates the identifying information to a network control device, such as a network operations center via a secure encrypted connection. A terminal identifier is also communicated with the user identification information. Alternatively, the identification information for both the user and the terminal can be communicated to a authentication server that has been replicated to a local server.

In one embodiment, a user database is queried to determine whether the user is an authorized user of the network. If the user is not an authorized user of the network, the user login attempt is refused. In one embodiment, if the user is an authorized user of the network and another user has logged in using the same identification, the second login attempt is refused and the first session is terminated with a security alert. If the user is identified as an authorized user of the network and is the only user attempting to login with the identity, the login is granted.

User privileges are determined at 520. In one embodiment, a middleware server in a network operations center queries the user database in the network operations center to determine a user profile for the user. The user profile includes the class of user and a set of user privileges and settings (e.g., application licenses, bookmarks, file access privileges, network access privileges, limited access to specific Web pages defined by specific URL allow and deny lists) for the user. The middleware server and/or the user database can be replicated to a local network.

Device privileges are determined at 530. In one embodiment, the middleware server in the network operations center queries an asset database in the network operations center to determine a terminal profile for the terminal. The terminal profile includes a set of device privileges (e.g., applications available, network connections). Alternatively, the middleware server and/or the asset database can be replicated to a server on a common local area network with the terminal.

In one embodiment, terminal privileges are determined by an entity higher than a terminal entity. In one embodiment, terminal privileges are related to terminal location based on the entity model described above with respect to FIG. 4. For example, terminals within a school can be provided with a common set of device privileges while terminals in another school have a different set of device privileges. In one embodiment, device privileges can be different for different classes of users. Different groups of terminals within a single location can also be provided with different sets of privileges. For example, a lab terminal can have different access privileges than a classroom terminal in the same school.

In one embodiment, the middleware server assigns a session identifier to the user-terminal combination. Use of a session identifier provides additional security by reducing the number of network transactions that include user and/or terminal identification information that can be used to identify the user. In one embodiment, the client application appends the session ID to all requests and/or connections. Other sensitive information can be communicated in a similar manner. In one embodiment, the middleware server determines session privileges based on the user profile and the terminal profile. In one embodiment, session privileges are the intersection of the user privileges and the device privileges; however, other session privileges can be granted, for example, by process or special case.

The terminal is configured at 540. In one embodiment, the terminal configuration includes granting access to resources based on the session privileges. In one embodiment, terminal configuration is accomplished via a client application running on the terminal that is configured based on the session privileges. For example, the client application can dynamically load, either from local storage or from the network operations center, a list of parameters including, but not limited to: active allow/deny Uniform Resource Locator (URL) list(s); a list of bookmarks to various resources; an appropriate user interface configuration file; and available local applications and resources.

The appropriate resources are provided at 550. In one embodiment resources are provided via a user interface described in greater detail below. The user interface is configured based, at least in part, on the session privileges.

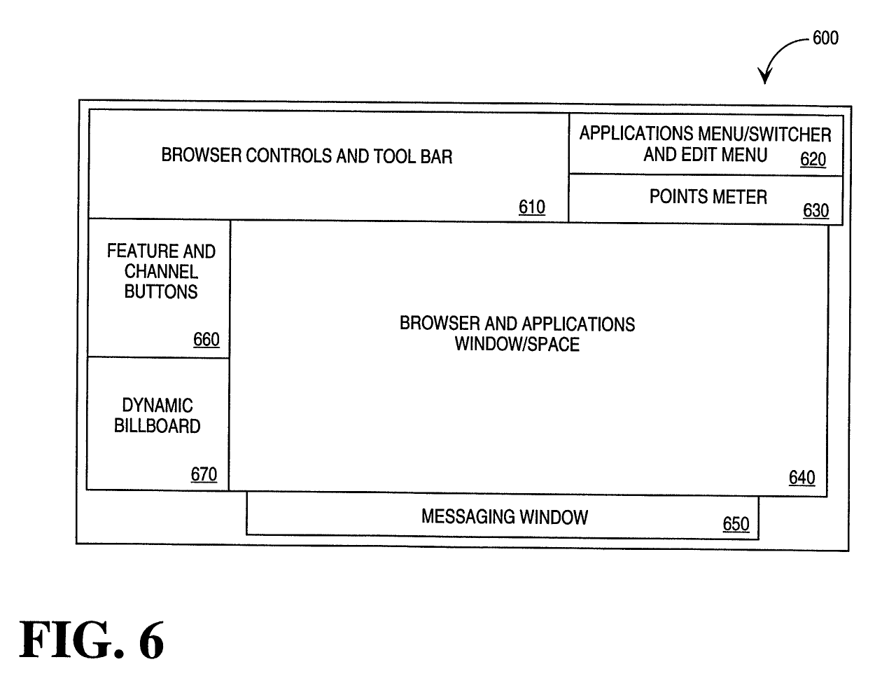

FIG. 6 is a layout of a graphical user interface according to one embodiment of the present invention. In one embodiment user interface 600 provided to a user of a terminal is configured based on the intersection of the user privileges and the terminal privileges. In one embodiment user interface 600 provides the gateway by which a user accesses both local and remote resources. Thus, the configuration of user interface 600, in part or in whole determines the resources to which the user has access.

In one embodiment browser controls and tool bar 610 provide graphical “buttons” that allow a user to perform certain operations. Browser controls and tool bar 610 can include, for example, “back,” “forward,” and “stop” buttons for browser control as well as “save,” “open,” and “print” buttons for general application control. Additional, fewer, and/or different buttons and commands can be included in browser control and tool bar 610 (e.g. the ability to type in a URL.).

In one embodiment applications menu/switcher and edit menu 620 provides application selection control and general editing control for multiple applications. For example, applications menu/switcher and edit menu 620 can include a list of all local and/or remote applications available to the user of the terminal on which user interface 600 is displayed. From the applications menu, the user can select an application to use. The edit portion provides general editing commands such as “cut,” “copy,” and “paste” for the user to move data between available applications.

In one embodiment points meter 630 provides a summary of incentive points or other points schemes available to the user. An incentive points management scheme is described in greater detail in U.S. patent application Ser. No. 09/XXX,XXX (P004) entitled “METHOD AND APPARATUS FOR INCENTIVE POINTS MANAGEMENT,” which is assigned to the corporate assignee of the present invention.

Browser and application window 640 provides space for the user to interact with the resources accessed. For example, if a word processing application is being used, browser and application window 640 displays the word processing application window when the application is activated. Thus, the user can switch between applications and move data between applications that are available on the terminal using menu/switcher and edit menu 620 should the current user have sufficient privileges to do so on the current terminal. If a browser application is being used, browser and application window 640 is used as a browser window.

In one embodiment feature and channel buttons 660 provide access to features (e.g., e-mail, chat rooms, message boards, bookmarks) and channels (e.g., educational topics, news topics) available to the user. Feature and channel buttons 660 are configured based on the session privileges such that only the features and channels available to or associated with the user appear. Feature and channel buttons control what is displayed in browser and applications window 640.

In one embodiment, dynamic billboard 670 provides advertising and/or other information to the user while the user is using an application or browser. One embodiment of an advertising implementation for dynamic billboard 670 is disclosed in U.S. patent application Ser. No. 09/XXX,XXX (P003) entitled “MICRO-TARGETED DIRECT ADVERTISING,” which is assigned to the corporate assignee of the present invention. Of course dynamic billboard advertising space 670 can be used for other purposes such as, for example, video conferencing, instant messaging, distance learning/instruction, news updates, or other uses.

In one embodiment, message window 650 can display messages to the user. For example, an instructor can send messages to students, a user of one terminal can send a message to a user of another terminal, a system administrator can send messages to a user or a group of users. Message window 650 can be used for messages that are independent of browser and applications window 640, so long as such messages are allowed by the current session privileges.

In the foregoing specification, the present invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. A method of managing a network, the method comprising:
determining session privileges based, at least in part, on an intersection of a set of user privileges for a user of a device and a set of device privileges for the device; and
providing access to resources based, at least in part, on the session privileges.

2. The method of claim 1 wherein the set of user privileges comprises:
access privileges to one or more local resources based, at least in part, on user identity; and
access privileges to one or more remote resources based, at least in part, on user identity.

3. The method of claim 1 wherein the set of user privileges is determined based, at least in part, on billing status.

4. The method of claim 1 wherein the set of device privileges comprises:
access privileges to one or more local resources based, at least in part, on device identity; and
access privileges to one or more remote resources based, at least in part, on device identity.

5. The method of claim 1 wherein one or more of the resources is a remote resource that has been replicated to a local area network to which the device is coupled.

6. The method of claim 1 wherein the device is a computer system.

7. The method of claim 1 wherein the device is a set-top box.

8. The method of claim 1 further comprising:
configuring a user interface based, at least in part, on the session privileges; and
granting access to resources based, at least in part, on selections made available to the user within the user interface.

9. A machine-readable medium having stored thereon sequences of instructions that when executed by a processor cause the processor to:
determine session privileges based, at least in part, on an intersection of a set of user privileges for a user of a device and a set of device privileges for the device; and
provide access to resources based, at least in part, on the session privileges.

10. The machine-readable medium of claim 9 wherein the set of user privileges comprises:
access privileges to one or more local resources based, at least in part, on user identity; and
access privileges to one or more remote resources based, at least in part, on user identity.

11. The machine-readable medium of claim 9 wherein the set of user privileges is determined based, at least in part, on billing status.

12. The machine-readable medium of claim 9 wherein the set of device privileges comprises:
access privileges to one or more local resources based, at least in part, on device identity; and
access privileges to one or more remote resources based, at least in part, on device identity.

13. The machine-readable medium of claim 9 wherein one or more of the resources is a remote resource that has been replicated to a local area network to which the device is coupled.

14. The machine-readable medium of claim 9 wherein the device is a computer system.

15. The machine-readable medium of claim 9 wherein the device is a set-top box.

16. The machine-readable medium of claim 9 further comprising sequences of instructions that when executed cause the processor to:
configure a user interface based, at least in part, on the session privileges; and
grant access to resources based, at least in part, on access to selections within the user interface.

17. An apparatus for managing a network, the apparatus comprising:
means for determining session privileges based, at least in part, on an intersection of a set of user privileges for a user of a device and a set of device privileges for the device; and
means for providing access to resources based, at least in part, on the session privileges.

18. The apparatus of claim 17 wherein the set of user privileges comprises:
access privileges to one or more local resources based, at least in part, on user identity; and
access privileges to one or more remote resources based, at least in part, on user identity.

19. The apparatus of claim 17 wherein the set of user privileges is determined based, at least in part, on billing status.

20. The apparatus of claim 17 wherein the set of device privileges comprises:
access privileges to one or more local resources based, at least in part, on device identity; and
access privileges to one or more remote resources based, at least in part, on device identity.

21. The apparatus of claim 17 wherein one or more of the resources is a remote resource that has been replicated to a local area network to which the device is coupled.

22. The apparatus of claim 17 wherein the device is a computer system.

23. The apparatus of claim 17 wherein the device is a set-top box.

24. The apparatus of claim 17 further comprising:
means for configuring a user interface based, at least in part, on the session privileges; and
means for granting access to resources based, at least in part, on selections made available to the user with the user interface.

25. A network comprising:
a plurality of terminals each having an associated set of device privileges for each class of supported users; and
a network operations center coupled to the plurality of terminals;
wherein a user having a set of user privileges is provided with access to resources based, at least in part, on session privileges that are an intersection of the user privileges and device privileges for a particular terminal while the user is using the particular terminal.

26. The network of claim 25 wherein one or more of the plurality of terminals are coupled as a local area network, and further wherein the local area network has a server that mirrors one or more resources available from the network operations center.

27. The network of claim 25 wherein the plurality of terminals include a computer system and a set-top box.

28. The network of claim 25 wherein the set of user privileges comprises:
access to one or more resources stored on the particular device based, at least in part, on user identity; and
access to one or more resources available via the network operations center based, at least in part, on user identity.

29. The network of claim 25 wherein the set of device privileges comprises:
access to one or more resources stored on the particular device based, at least in part, on device identity; and
access to one or more resources available via the network operations center based, at least in part, on device identity.
